(19) United States
(12) Patent Application Publication
(10) Pub. No.: US 2005/0163352 A1
(43) Pub. Date: Jul. 28, 2005

(54) Image collating apparatus, image collating method, image collating program and computer readable recording medium recording image collating program, allowing image input by a plurality of methods

(75) Inventors: Yasufumi Itoh, Tenri-shi (JP); Manabu Yumoto, Nara-shi (JP); Manabu Onozaki, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/024,859

(22) Filed: Dec. 30, 2004

(30) Foreign Application Priority Data
Jan. 26, 2004 (JP) 2004-017412(P)

(51) Int. Cl. G06K 9/00

(52) U.S. Cl. 382/124

(57) ABSTRACT

In an image collating apparatus, a method of fingerprint input and collation (sensing method) is determined in accordance with confidentiality level of an application that is being executed at present, and fingerprint data is input either by sweep sensing method or area sensing method. Regardless of the input method, similarity score of the input fingerprint data to a read reference image is calculated for collation, and a result of determination is output.

This nonprovisional application is based on Japanese Patent Application No. 2004-017412 filed with the Japan Patent Office on Jan. 26, 2004, the entire contents of which are hereby incorporated by reference.

### BACKGROUND OF THE INVENTION

1. Field of the Invention

The present invention relates to an image collating apparatus, an image collating method, an image collating program and a computer readable recording medium recording the image collating program. More specifically, the present invention relates to an image collating apparatus, an image collating method, an image collating program and a computer readable recording medium recording the image collating program for collating images with each other, switching between sweep sensing method and area sensing method.

2. Description of the Background Art

Conventional methods of collating fingerprint images can be classified broadly into image feature matching method and image-to-image matching method. In the former, image feature matching, images are not directly compared with each other but features in the images are extracted and the extracted image features are compared with each other, as described in KOREDE WAKATTA BIOMETRICS (Edited by Nippon Jidou Ninnshiki Sisutemu Kyoukai, OHM sha: pp.42-44). When this method is applied to fingerprint image collation, minutiae (ridge characteristics of a fingerprint that occur at ridge bifurcations and ending, and few to several minutiae can be found in a fingerprint image) such as shown in FIGS. 15A and 15B serve as the image feature. According to this method, from images such as shown in FIGS. 16A and 16B, minutiae such as shown in FIGS. 16C and 16D are extracted by image processing. Then, based on the positions, types and ridge information of the extracted minutiae, a similarity score is determined as the number of minutiae of which relative position and direction match among the images; the similarity score is incremented/decremented in accordance with match/mismatch in, for example, the number of ridges traversing the minutiae; and the similarity score thus obtained is compared with a predetermined threshold for collation and identification.

In the latter method, that is, in image-to-image matching, from images α (FIG. 17A) and β (FIG. 17B) to be collated with each other, partial image α1 (FIG. 17C) and partial image β1 (FIG. 17D), that may correspond to the full area or partial area, are extracted; matching score between partial images α1 and β1 is calculated based on total sum of difference values, correlation coefficient, phase correlation method or group delay vector method, as the similarity score between images α and β; and the calculated similarity score is compared with a predetermined threshold for collation and identification.

Inventions utilizing the image-to-image matching method have been disclosed, for example, in Japanese Patent Laying-Open No. 63-211081 (Reference 1) and Japanese Patent Laying-Open No. 63-078286 (Reference 2). In Reference 1, first, an object image is subjected to image-to-image matching, the object image is then divided into four small areas, and in each divided area, positions that attain maximum matching score in peripheral portions are found, and an average matching score is calculated therefrom, to obtain a corrected similarity score. This approach addresses distortion or deformation of fingerprint images that inherently occur at the time the fingerprints are collected. In Reference 2, one fingerprint image is compared with a plurality of partial areas that include features of the one fingerprint image, while substantially maintaining positional relation among the plurality of partial areas, and total sum of matching scores of the fingerprint image with respective partial areas is calculated and provided as the similarity score.

Problems of the image-to-image matching method and image feature matching method are disclosed in paragraphs [0006] to [0010] of Japanese Patent Laying-Open No. 2003-323618 (Reference 3), which was filed earlier by the applicant of the present application and laid-open.

Referring to this disclosure, conventionally, it has been impossible to always obtain exact data when image data is input through a sensor. When image data of a fingerprint, for example, is input through a sensor, it is difficult to obtain exact image data, as there are positional deviation or inclination, difference in pressure when one presses his/her finger on the sensor, or expansion or contraction of finger skin when one moves his/her finger. When the skin surface is dry or sweaty, image data may be thin or blurred, dependent on the sensing method.

In the image feature matching method utilizing minutiae of fingerprints, when there is a thin spot, a ridge that is actually continuous may possibly be found discontinuous, resulting in erroneous extraction of minutiae that do not actually exist, and when there is a blur, minutiae information cannot correctly be extracted. Thus, stable image feature extraction is difficult. It is not the case that minutiae are distributed uniformly over finger surfaces of everyone, and there may be only a very small number of minutiae, or only an extremely small number of minutiae match when position deviates, dependent on minutiae distribution. Therefore, when the similarity score is based on the number of matching minutiae, similarity score would be decreased.

In case of image-to-image matching where similarity score is found between the entire fingerprint images, the feature such as the minutiae is not used, and therefore, this method is less susceptible to the influence of thin spots or blur. When the fingerprint image is inclined or expanded/contracted, however, mismatching portions between fingerprint images increase even if the images come from one same fingerprint, and hence similarity score between the fingerprint images decreases. When a plurality of partial images including features of the fingerprint images are used, it is possible to cope with inclination or expansion/contraction to some extent appearing in the fingerprint images. The matching score of images of the partial area used as the similarity score is rather sensitive to the variation in the fingerprint images. Therefore, it is not always possible to attain high similarity score even if two fingerprint images come from one same person, and the similarity score may decrease dependent on the inclination or manner of pressing of the finger or dependent of dryness of the finger surface.

When the similarity score decreases to be lower than a predetermined threshold, the fingerprint images that come from one same finger would be erroneously determined to be images of different fingers. When the threshold is set lower to avoid such erroneous determination, however, possibility that fingerprints of different fingers are erroneously determined to come from one same finger increases.

As described above, conventionally, images are collated based on the similarity score that comes from the matching score between image features or between image data. Even when image data of one same object are handled, however, the matching score easily decreases because of conditional variations at the time of image data input. Thus, it has been difficult to stably attain high collation accuracy.

Generally speaking, the image-to-image matching method is more robust to noise and finger condition variations (dryness, sweat, abrasion and the like), while the image feature matching method enables higher speed of processing than the image-to-image matching as the amount of data to be compared is smaller, and therefore, matching is possible by searching for relative position or direction of feature points.

In order to solve the problems of the image-to-image matching method and image feature matching method, Reference 3 mentioned above proposes an approach in which positions of maximum matching score where each of a plurality of partial area images (FIGS. 18A, 18B) set in one of two images attain maximum matching score in the other image are searched for, and each of the plurality of positions of maximum matching score is compared with a preset threshold, so as to calculate similarity score between the two images.

Conventional methods of inputting fingerprint images can be basically classified into sweep sensing method (FIG. 19) and area sensing method (FIG. 20).

One example of the sweep sensing method is disclosed in Japanese Patent Laying-Open No. 5-17413 3 (Reference 4).

In area sensing method, fingerprint information sensed at one time on a full area is input, and in the sweep sensing method, the fingerprint is sensed while one moves his/her finger on a sensor. Reference 3 discloses a technique related to the area sensing method. When area sensing method is used, it is necessary to provide a sensor of a larger area than that used in the sweep sensing method, to attain higher accuracy of fingerprint identification. Further, when a semiconductor sensor is used, cost-to-area ratio is not good, as the material cost of silicon is rather high. Therefore, sweep sensing method is more advantageous for portable equipments that has small area for mounting and requires much cost reduction. Though the sweep sensing method has advantages of smaller mounting area and lower cost, it also has a disadvantage of longer time required for collation, as compared with the area sensing method.

When the sweep type sensor is used, however, sweep sensing method is always adopted, so that it is necessary for the user to move his/her finger on the sensor for sensing. This is less convenient for the user as compared with area sensing using an area sensor.

In the conventional authentication technique using the sweep type sensor, the user's time and labor are almost the same regardless of the required level of security. Specifically, no matter whether the user accesses to a portion of high confidentiality or lower confidentiality where strict authentication is not a prime necessity, the user must move his/her finger on the sensor for sensing. In other words, it was impossible to adjust trade-off between convenience and confidentiality.

It is needless to say that the convenience for the user can be improved when an area type sensor is used. This approach, however, involves higher cost, because of the higher cost of the sensor and the larger area required for mounting.

### SUMMARY OF THE INVENTION

The present invention was made in view of the foregoing, and its object is to provide an image collating apparatus, an image collating method, an image collating program and a computer readable recording medium recording the image collating program, in which sweep sensing method and area sensing method are switched in accordance with the confidentiality level or user setting, enabling switching between a highly accurate method for higher confidentiality and a easier method where convenience is given priority, using conventional sweep type or similar sensor without necessitating additional cost for the sensor and suppressing the cost as compared with the use of the area type sensor.

In order to attain the above-described objects, according to an aspect, the present invention provides an image collating apparatus, including: an image input unit including a sensor and allowing input of an image of an object either through a first method in which relative position between the sensor and the object is fixed or a second method in which relative position between the sensor and the object is changed; a reference image holding unit holding a reference image to be collated with an input image input to the image input unit; a first collating unit collating a first input image input to the image input unit through the first method with the reference image; a second collating unit collating a second input image input to the image input unit through the second method with the reference image; a purpose information storing unit storing information related to a purpose of collation of the input image; a determining unit determining, in accordance with the purpose of collation stored in the purpose information storing unit, whether an image of the object is to be input to the image input unit through the first method to be collated by the first collating unit, or an image of the object is to be input to the image input unit through the second method to be collated by the second collating unit; and selecting unit selecting either the first method or the second method as the method of inputting the image of the object to the image input unit, in accordance with the result of determination by the determining unit.

Preferably, the purpose information storing unit stores,.as the information related to the purpose of collation, a confidentiality level related to an application being executed by the image collating apparatus; and the determining unit determines, in accordance with the confidentiality level related to an application being executed by the image collating apparatus stored in the purpose information storing unit, whether an image of the object is to be input to the image input unit through the first method to be collated by the first collating unit, or an image of the object is to be input to the image input unit through the second method to be collated by the second collating unit.

Preferably, the image collating apparatus further includes: a setting information holding unit, receiving a setting as to whether an image of the object is to be input to the image input unit through the first method to be collated by the first collating unit, or an image of the object is to be input to the image input unit through the second method to be collated by the second collating unit, in accordance with the information related to the purpose of collation and holding the setting; wherein the determining unit determines, based on the setting held by the setting information holding unit, whether an image of the object is to be input to the image input unit through the first method to be collated by the first collating unit, or an image of the object is to be input to the image input unit through the second method to be collated by the second collating unit.

More preferably, the setting information holding unit is a rewritable memory that allows resetting as to whether an image of the object is to be input to the image input unit through the first method to be collated by the first collating unit, or an image of the object is to be input to the image input unit through the second method to be collated by the second collating unit.

According to another aspect, the present invention provides an image collating method, including: an image input step of inputting an image of an object by image input means allowing input of an image of the object either through a first method in which relative position between the sensor and the object is fixed or a second method in which relative position between the sensor and the object is changed, either through the first method or the second method; a determining step of determining, in accordance with information related to a purpose of collation, whether the image of the object is input through the first method or second method in the image input step; a selecting step of selecting, in accordance with the result of determination of the determining step, either the first method or the second method as the method of inputting an image of the object in the image input step; a first collating step of collating, when the first method is selected in the selecting step as the method of inputting an image of the object in the image input step, a first input image input through the first method in the image input step with a reference image for collation with the input image input in the image input step; and a second collating step of collating, when the second method is selected in the selecting step as the method of inputting an image of the object in the image input step, a second input image input through the second method in the image input step with the reference image.

According to a still further aspect, the present invention provides an image collating program causing a computer to execute an image collating method, the method including an image input step of inputting an image of an object by image input means allowing input of an image of the object either through a first method in which relative position between the sensor and the object is fixed or a second method in which relative position between the sensor and the object is changed, either through the first method or the second method; a determining step of determining, in accordance with information related to a purpose of collation, whether the image of the object is input through the first method or second method in the image input step; a selecting step of selecting, in accordance with the result of determination of the determining step, either the first method or the second method as the method of inputting an image of the object in the image input step; a first collating step of collating, when the first method is selected in the selecting step as the method of inputting an image of the object in the image input step, a first input image input through the first method in the image input step with a reference image for collation with the input image input in the image input step; and a second collating step of collating, when the second method is selected in the selecting step as the method of inputting an image of the object in the image input step, a second input image input through the second method in the image input step with the reference image.

According to a still further aspect, the recording medium is a computer readable recording medium that records the image collating program described above.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram representing a functional configuration of the image collating apparatus in accordance with a first embodiment of the present invention.

FIG. 2A is an illustration showing a sensing operation in accordance with the sweep method using a fingerprint sensor of the image collating apparatus of FIG. 1.

FIG. 2B is an illustration showing a sensing operation in accordance with the area method using a fingerprint sensor of the image collating apparatus of FIG. 1.

FIG. 3 shows an exemplary configuration of a computer on which the image collating apparatus in accordance with the first embodiment is mounted.

FIG. 4 is a flow chart representing the image collating method in accordance with the first embodiment.

FIG. 5 is a flow chart representing a process of determining the fingerprint input method and collation method in step T0.

FIG. 6 is a flow chart representing a process of calculating relative positional relation between snapshots Ak in step T23.

FIGS. 7A to 7E show specific examples of snap shot images for the image collating apparatus shown in FIG. 1.

FIG. 8 shows a specific example of the snap shot images of FIGS. 7A to 7E with their relative positional relation corrected.

FIG. 9 is a flow chart representing the collating process performed in step T4 of FIG. 4 when the fingerprint input and collating are performed in accordance with the sweep method.

FIG. 10 is a flow chart representing the collating process performed in step T4 of FIG. 4 when the fingerprint input and collating are performed in accordance with the area method.

FIG. 11 is an illustration showing an exemplary setting of the partial areas in the snap shot images.

FIG. 12 illustrates movement vectors and their distributions of the snap shot images that have been corrected as shown in FIG. 8.

FIG. 13 is a flow chart representing the procedure for a user to set either the area method or the sweep method as the fingerprint input and collating method, application by application.

FIG. 14 is a flow chart representing a process for determining the fingerprint input and collating method in step T0, in accordance with a second embodiment of the present invention.

FIGS. 15A and 15B are schematic diagrams representing minutiae as image features used in the prior art.

FIGS. 16A to 16D represent the image feature matching method as a prior art.

FIGS. 17A to 17D represent the image-to-image matching method as a prior art.

FIGS. 18A to 18C represent result of searching for position with high matching score among a plurality of partial areas of a pair of fingerprint images taken from one same finger, and movement vector and distribution of each partial area.

FIG. 19 illustrates the sweep sensing method as a conventional method of fingerprint input.

FIG. 20 illustrates the area sensing method as a conventional method of fingerprint input.

### DESCRIPTION OF THE PREFERRED EMBODIMENTS

In the following, embodiments of the present invention will be described with reference to the figures. In the following, the same parts and components are denoted by the same reference characters. Their names and functions are also the same. Therefore, detailed description thereof will not be repeated.

Though fingerprint data will be described as an exemplary image data to be collated, the image is not limited thereto, and the present invention may be applicable to image data of other biometrics that are similar among samples (individuals) but not identical, or other image data of linear patterns.

### First Embodiment

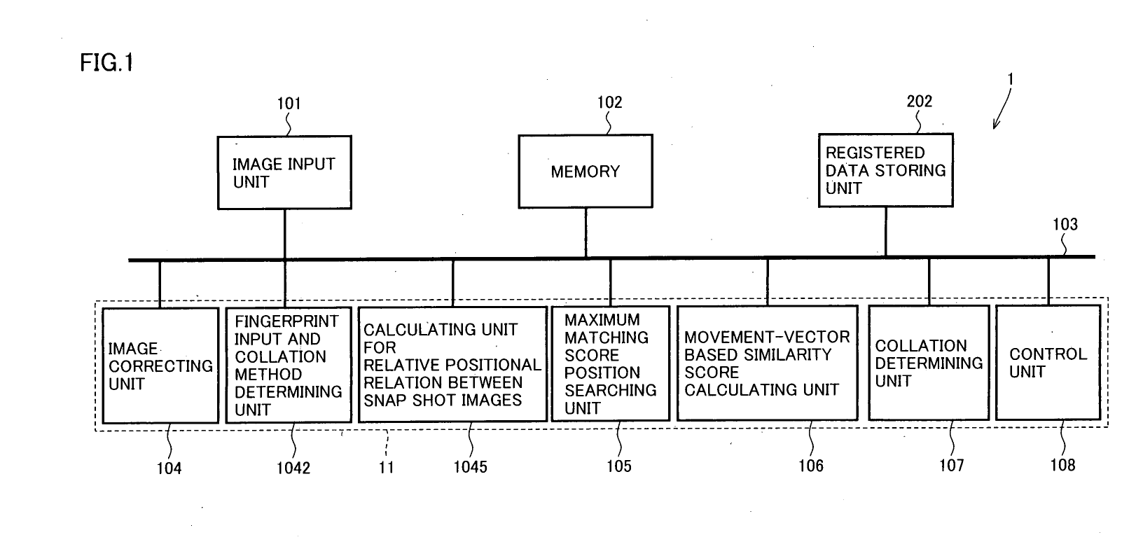

Referring to FIG. 1, an image collating apparatus 1 in accordance with the first embodiment includes an image input unit 101, a memory 102 that corresponds to a memory 624 or a fixed disk 626 (FIG. 3), a bus 103, a registered data storing unit 202, and a collating unit 11.

Collating unit 11 includes an image correcting unit 104, a fingerprint input and collation method determining unit 1042, a calculating unit 1045 for relative positional relation between snap shot images, a maximum matching score position searching unit 105, a movement-vector-based similarity score calculating unit (hereinafter referred to as a similarity score calculating unit) 106, a collation determining unit 107 and a control unit 108. Functions of these units in collating unit 11 are realized when corresponding programs are executed.

In image collating apparatus 1 shown in FIG. 1, image input unit 101 is used for an image input unit; registered data storing unit 202 is used for a reference image holding unit; memory 102 is used for a purpose information storing unit; fingerprint input and collation method determining unit 1042 is used for a determining unit; maximum matching score position searching unit 105, similarity score calculating unit 106 and collation determining unit 107 are used for a first collating unit; and a calculating unit 1045 for relative positional relation between snap shot images, maximum matching score position searching unit 105, similarity score calculating unit 106, and, collation determining unit 107 are used for a second collating unit. Memory 102 and control unit 108 have the function of general storage and control of the entire components.

Image input unit 101 includes a fingerprint sensor, and outputs a fingerprint image data that corresponds to the fingerprint read by the fingerprint sensor. The fingerprint sensor may be an optical, a pressure-type, a static capacitance type or any other type sensor.

The fingerprint sensor included in image input unit 101 can operate in accordance with both the sweep sensing method (hereinafter simply referred to as sweep method) and the area sensing method (hereinafter simply referred to as area method) described above, and it can read fingerprint data sensed by either of these methods.

Specifically, when the fingerprint data is to be sensed by the sweep method using the fingerprint sensor at image input unit 101, the user is requested to place his/her finger at right angles to the longitudinal direction of the rectangular sensor, and to move his/her finger downward (or upward) perpendicular to the longitudinal direction of the sensor, so that the fingerprint data is read.

When the fingerprint data is to be sensed by the area method, the user is requested to place his/her finger on the sensor parallel to the longitudinal direction of the rectangular sensor, and the fingerprint data is read while the finger is kept stationary on the sensor.

The size of the fingerprint sensor provided at image input unit 101 must be equal to or larger than the minimum necessary size for sensing by the area method. The width, which corresponds to the length of the sensor in the longitudinal direction, must be about 1.5 times the width of the finger (256 pixels), and the length, which corresponds to the length of the sensor in the direction orthogonal to the longitudinal direction, must be about 0.25 times the width of the finger (64 pixels).

In image collating apparatus 1 in accordance with the present embodiment, when the fingerprint data is sensed by the area method, attained accuracy of collation is not very high, as the fingerprint sensor having the length of about 0.25 times the finger width is used. The necessary time, however, is shorter than that for the sweep method, and therefore, it is suitably used for simple fingerprint identification and convenient for the user. When the fingerprint data is sensed by the sweep method, it takes longer time, while collation accuracy is higher. Therefore, it can be used for fingerprint identification required for highly confidential purposes.

Memory 102 stores image data and various calculation results. Bus 103 is used for transferring control signals and data signals between each of these units. Image correcting unit 104 performs density correction of the fingerprint image input from image input unit 101.

Maximum matching score position searching unit 105 uses a plurality of partial areas of one fingerprint image as templates, and searches for a position of the other fingerprint image that attains to the highest matching score with the templates. Namely, it performs the so-called template matching. The result of searching, that is, the resulting information is passed to and stored in memory 102.

Using the information of the result from maximum matching score position searching unit 105 stored in memory 102, similarity score calculating unit 106 calculates the movement-vector-based similarity score, which will be described later. The calculated similarity score is passed to collation determining unit 107. Collation determining unit 107 determines a match/mismatch, based on the similarity score calculated by similarity score calculating unit 106.

Control unit 108 controls processes performed by various units of collating unit 11. In registered data storing unit 202, only the data portions used for collation are stored in advance, from images different from the set of snap shot images to be collated.

In the present embodiment, part of or all of the image correcting unit 104, fingerprint input and collation method determining unit 1042, calculating unit 1045 for relative positional relation between snap shot images, maximum matching score position searching unit 105, similarity score calculating unit 106, collation determining unit 107 and control unit 108 may be implemented by an ROM (Read Only Memory) such as memory 624 (FIG. 3) storing the process procedure as a program and a processor such as CPU (Central Processing Unit) 622 (FIG. 3) for executing the program.

Next, referring to FIG. 3, a specific example of the computer configuration, on which image collating apparatus 1 of the present embodiment is mounted, will be described.

Referring to FIG. 3, the computer includes an image input unit 101, a display 610 such as a CRT (Cathode Ray Tube) or a liquid crystal display, a CPU 622 for central management and control of the computer itself, a memory 624 including an ROM or an RAM (Random Access Memory), a fixed disk 626, an FD drive 630 on which an FD (flexible disk) 632 is detachably mounted and which accesses to FD 632 mounted thereon, a CD-ROM drive 640 on which a CD-ROM (Compact disc Read Only Memory) is detachably mounted and which accesses to the mounted CD-ROM 642, a communication interface 680 for connecting the computer to a communication network 300 for establishing communication, and an input unit 700 having a key board 650 and a mouse 660. These components are connected through a bus for communication. Further, it is connected to a printer 690 as an external apparatus.

The configuration shown in FIG. 3 is a general computer configuration, and the present embodiment is not limited to the configuration of FIG. 3. The computer may be provided with a magnetic tape apparatus accessing to a cassette type magnetic tape that is detachably mounted thereto.

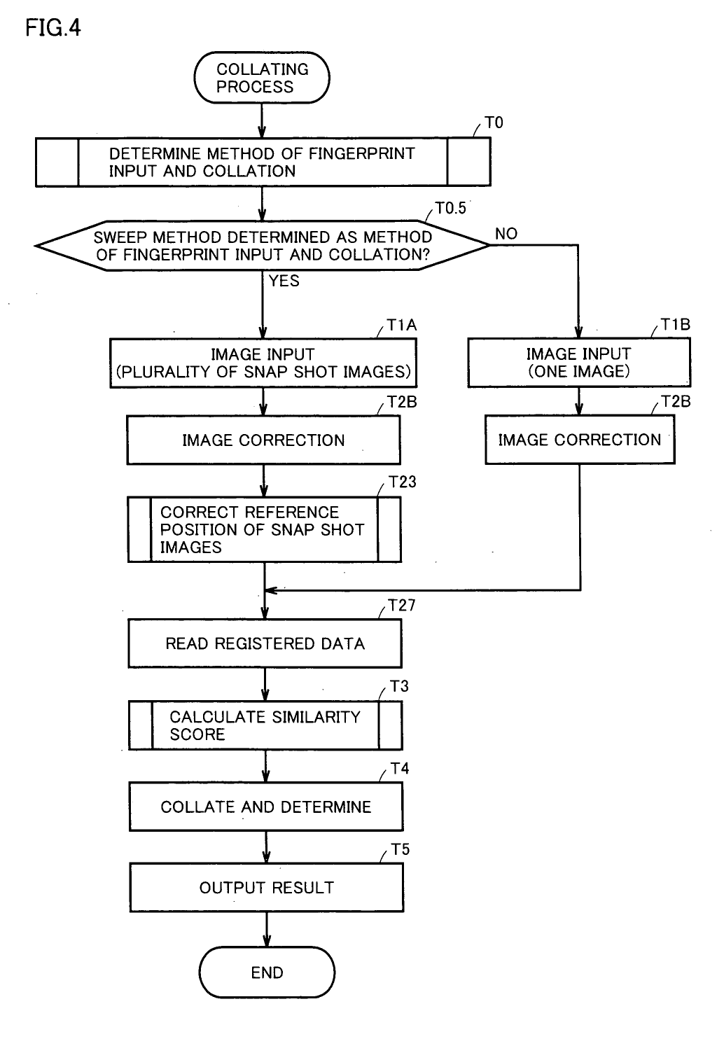

The method of image collation by image collating apparatus 1 shown in FIG. 1 will be described with reference to the flow chart of FIG. 4. The process shown in the flow chart of FIG. 4 is realized when CPU 622 of the computer, on which image collating apparatus 1 of the present embodiment is mounted, reads a corresponding program stored in an ROM or the like, executes the same on an RAM to control various components shown in FIG. 1.

Referring to FIG. 4, first, a process (step T0) for determining the method of fingerprint input and collation (sensing method) is executed by control unit 108, and the method of fingerprint input and collation is determined.

The step T0 of determining the method of fingerprint input and collation of the first embodiment will be described in detail with reference to FIG. 5. Referring to FIG. 5, first, in control unit 108, the confidentiality level of the application, which is being executed, is read from memory 102 (S10). Here, confidentiality level means degree of accuracy of individual authentication required for accessing to the application. The confidentiality level is set in advance application by application, and stored in memory 102 for each application.

When the application that is being executed at present has high confidentiality level (YES in S20), that is, when highly accurate individual authentication is required, sweep method is output (S30), and otherwise (NO in S20), the area method is output (S40).

Again referring to FIG. 4, when the area method is output as the method of fingerprint input and collation in step T0 (NO in S20), it is determined by fingerprint input and collation method determining unit 1042 (NO in T0.5), and the flow proceeds to step T1B, where the following process is executed.

Specifically, in step T1B, first, control unit 108 transmits an image input start signal to image input unit 101, and thereafter waits until an image input end signal is received. Image input unit 101 receives as an input image A for collation, which image is stored at a prescribed address of memory 102 through bus 103. After the input of image A is completed, image input unit 101 transmits the image input end signal to control unit 108.

Thereafter, control unit 108 transmits an image correction start signal to image correcting unit 104, and thereafter, waits until an image correction end signal is received. In most cases, the input image has uneven image quality, as tones of pixels and overall density distribution vary because of variations in characteristics of image input unit 101, dryness of fingerprints and pressure with which fingers are pressed. Therefore, it is not appropriate to use the input image data directly for collation. Image correcting unit 104 corrects the image quality of input image to suppress variations of conditions when the image is input (step T2B). Specifically, for the overall image corresponding to the input image or small areas obtained by dividing the image, histogram planarization (Computer GAZOU SHORI NYUMON (Introduction to computer image processing, SOKEN SHUPPAN, p.98), or image thresholding (binarization) (Computer GAZOU SHORI NYUMON (Introduction to computer image processing, SOKEN SHUPPAN, pp. 66-69) is performed, on image A stored in memory 102.

After the end of image correcting process on image A, image correcting unit 104 transmits the image correction end signal to control unit 108.

When the sweep method is output as the method of fingerprint input and collation in step T0 (YES in S20), it is determined by fingerprint input and collation method determining unit 1042 (YES in T0.5), and the flow proceeds to step T1A, where the following process is executed.

Specifically, in step T1A, first, control unit 108 transmits an image input start signal to image input unit 101, and thereafter waits until an image input end signal is received. Image input unit 101 receives as an input image Ak for collation, which image is stored at a prescribed address of memory 102 through bus 103. After the input of image Ak is completed, image input unit 101 transmits the image input end signal to control unit 108.

Thereafter, control unit 108 transmits an image correction start signal to image correcting unit 104, and thereafter, waits until an image correction end signal is received. As described above, in most cases the input image has uneven image quality, as tones of pixels and overall density distribution vary because of variations in characteristics of image input unit 101, dryness of fingerprints and pressure with which fingers are pressed. Therefore, it is not appropriate to use the input image data directly for collation. Image correcting unit 104 corrects the image quality by performing such processes as described above on image Ak stored in memory 102, to suppress variations of conditions when the image is input (step T2A).

After the end of image correcting process on image Ak, image correcting unit 104 transmits the image correction end signal to control unit 108.

Thereafter, a process for calculating relative positional relation between snap shot images Ak (step T23) is performed. The process of step T23 will be described in detail later, with reference to a subroutine.

When the process for calculating relative positional relation between snap shot images Ak of step T23 ends, control unit 108 transmits a registered data read start signal to registered data reading unit 207, and waits until a registered data read end signal is received.

Receiving the registered data read start signal, registered data reading unit 207 reads data of a partial area Ri of a registered image B from registered data storing unit 202, and stores the same at a prescribed address of memory 102 (step T27).

Then, the process for calculating similarity between an image A (or Ak) as an object of collation and a reference image is performed (step T3). The process of step T3 will be described in detail later with reference to a subroutine.

When the collaring process of step T3 ends, control unit 108 transmits a collation determination start signal to collation determining unit 107, and waits until a collation determination end signal is received. Collation determining unit 107 collates and determines, using the result of calculation of step T3 (step T4). Specific method of determination of step T4 will be described in detail later, in connection to the similarity calculating process of step T3.

When determination of step T4 ends, the collation result, that is the result of collation and determination, is stored in memory 102, and collation determining unit 107 transmits the collation determination end signal to control unit 108.

Finally, control unit outputs the collation result stored in memory 102 through display 610 or printer 690 (step T5), and the collating process ends.

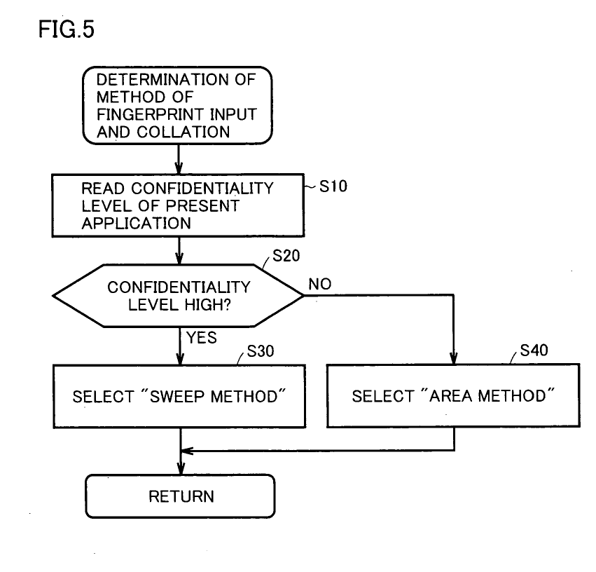

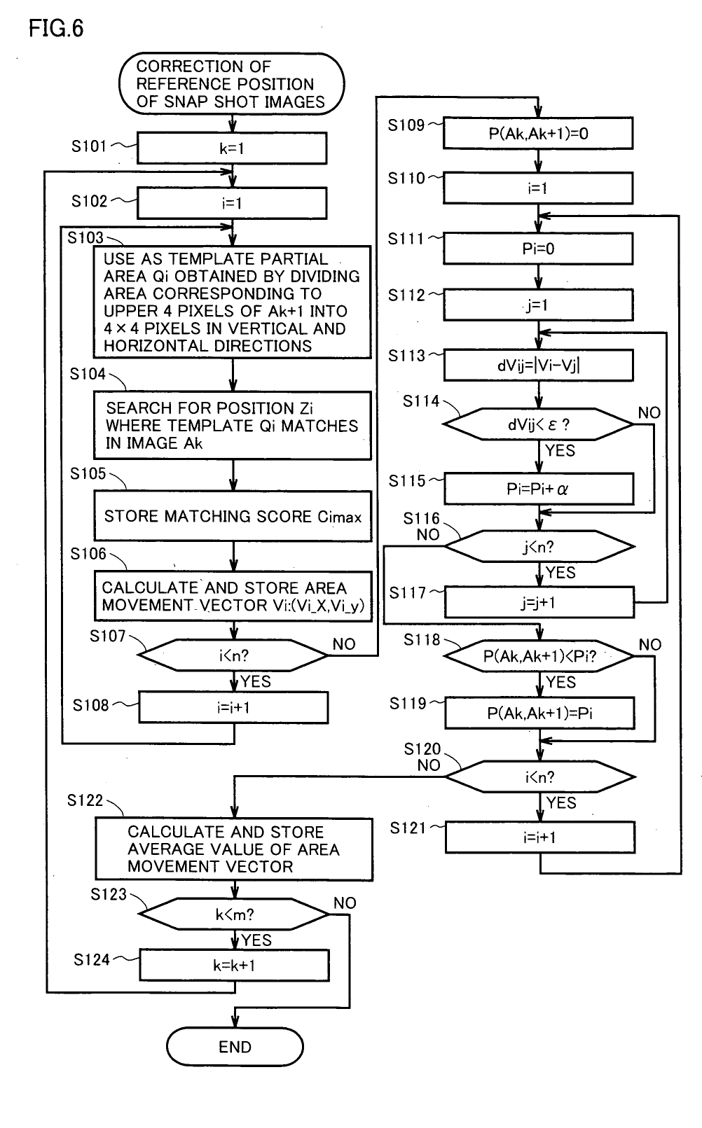

Next, the process of step T23 will be described with reference to FIG. 6.

First, control unit 108 transmits a template matching start signal to calculating unit 1045 for relative positional relation between snap shot images, and waits until a template matching end signal is received. In calculating unit 1045 for relative positional relation between snap shot images, the template matching process such as shown from step S101 to S108 starts.

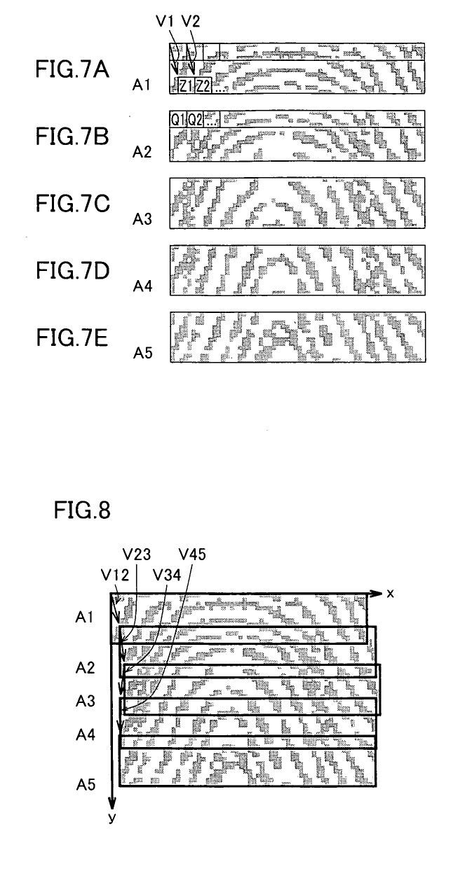

The template matching process here is to find the maximum matching score position between snap shot images Ak and Ak+1, that is, a process for searching, for each of a plurality of partial area images of an image Ak+1, which partial area of image Ak attains the best match. By way of example, consider images A1 to A5 shown in FIGS. 7A to 7E. For each of a plurality of partial images Q1, Q2, . . . of snap shot image A2 shown in FIG. 7B, that one of the partial images Z1, Z2, . . . of snap shot image A1 of FIG. 7A which attains the best match is searched for. Similarly, for each partial area in images A3, A4 and A5 shown in FIGS. 7C, 7D and 7E, best match positions are searched for from partial images of images A2, A3 and A4 shown in FIGS. 7B, 7C and 7D, respectively.

Referring to FIG. 6, first, in steps S101 and S102, counter variable k and variable i are initialized to 1. Next, in step S103, an area corresponding to upper four pixel lines of image Ak+1 is defined as partial area Q1 that is divided into 4 pixels in the vertical direction×4 pixels in the horizontal direction, and the image of this partial area is set as a template to be used for the template matching. Though the partial area Q1 has a rectangular shape for simplicity of calculation, the shape is not limited thereto.

In step S104, a portion of image Ak having the highest matching score with the template set in step S103, that is, a portion at which image data best match the template, is searched for. Specifically, we represent pixel density of coordinates (x, y), with an upper left corner of partial area Qi used as the template being the origin by Qi (x, y), pixel density of coordinates (s, t), with an upper left corner of image Ak being the origin by Ak(s, t), the width and height of partial area Qi by w and h, respectively, possible maximum density of each pixel in partial area Q1 and image Ak by V0, and the matching score at coordinates (s, t) of image Ak by Ci(s, t), which matching score is calculated in accordance with the following equation (1), based on density difference between each of the pixels.

$$Ci ( s , t ) = {\sum }_{y = 1}^{h} {\sum }_{x = 1}^{w} ( V0 - \vert Qi ( x , y ) - Ak ( s + x , t + y ) \vert ) \qquad ( 1 )$$

In image Ak, the coordinates (s, t) are successively updated and the matching score C(s, t) is calculated. A position having the highest value is considered as the maximum matching score position, the image of the partial area at that position is represented as partial area Zi, and the matching score at that position is represented as maximum matching score Cimax.

In step S105, the maximum matching score Cimax in image Ak for the partial area Qi calculated in step S104 is stored in a prescribed address of memory 102. In step S106, a movement vector Vi is calculated in accordance with equation (2), which is stored at a prescribed address of memory 102.
Vi=(Vix, Viy)=(Zix−Qix, Ziy−Qiy) (2)

Here, if the image Ak is scanned to identify the partial area Zi at the position Z having the highest matching score with the partial area Qi, based on the partial area Qi at position Q set in image Ak+1, a directional vector from position Q to position Z is referred to as a movement vector.

In equation (2), variables Qix and Qiy are x and y coordinates at the reference position of partial area Qi, that correspond, by way of example, to the upper left corner of partial area Qi in image Ak. Variables Zix and Ziy are x and y coordinates at the position of maximum matching score Cimax as the result of search of partial area Zi, which correspond, by way of example, to the upper left corner coordinates of partial area Zi at the matched position in image Ak.

In step S107, whether the counter variable i is not larger than the total number of partial areas n or not is determined. If the variable i is not larger than the total number n of the partial areas, the flow proceeds to step S108, and otherwise, the process proceeds to step S109.

In step S108, 1 is added to variable value i. Thereafter, as long as the variable value i is not larger than the total number n of partial areas, steps S103 to S108 are repeated, and for every partial area Qi, template matching is performed. Thus, maximum matching score Cimax of each partial area Qi and the movement vector Vi are calculated.

Maximum matching score position searching unit 105 stores the maximum matching score Cimax and the movement vector Vi for every partial area Qi calculated successively as described above at prescribed addresses of memory 102, and thereafter transmits a template matching end signal to control unit 108 to end the processing.

Thereafter, control unit 108 transmits a similarity score calculation start signal to similarity score calculating unit 106, and waits until a similarity score calculation end signal is received. Similarity score calculating unit 106 calculates the similarity score through the process of steps S109 to S121 of FIG. 6, using information such as the movement vector Vi and the maximum matching score Cimax of each partial area Qi obtained by template matching and stored in memory 102.

Here, the calculation of similarity score refers to a process for calculating similarity between two images Ak and Ak+1, using the maximum matching score positions corresponding to respective ones of the plurality of partial areas obtained through the template matching process described above. Details will be described in the following. Generally, the data of snap shot images are data of one same person, and therefore, in most cases, the similarity score calculation is unnecessary.

In step S109, similarity score P (Ak, Ak+1) is initialized to 0. Here, the similarity score P(Ak, Ak+1) is a variable storing the degree of similarity between images Ak and Ak+1. In step S110, an index i of the movement vector Vi as a reference is initialized to 1. In step S111, similarity score Pi related to the reference movement vector Vi is initialized to 0. In step S112, an index j of movement vector Vj is initialized to 1.

In step S113, vector difference dVij between reference movement vector Vi and movement vector Vj is calculated in accordance with equation (3).
dVij=|Vi−Vj|=sqrt {(Vix−Vjx)²+(Viy−Vjy)²} (3)
Here, variables Vix and Viy represent x direction and y direction components, respectively, of the movement vector Vi, variables Vjx and Vjy represent x direction and y direction components, respectively, of the movement vector Vj, variable sqrt(X) represents square root of X and X² represents calculation of square of X.

In step S114, vector difference dVij between movement vectors Vi and Vj is compared with a prescribed constant value ε, so as to determine whether the movement vectors Vi and Vj can be regarded as substantially the same vectors. If the vector difference dVij is smaller than the constant value ε (YES in S114), movement vectors Vi and Vj are regarded as substantially the same, and the flow proceeds to step S115. If the difference is larger than the constant value (NO in S114), the movement vectors cannot be regarded as substantially the same, and the flow proceeds to step S116. In step S115, the similarity score Pi is incremented in accordance with equations (4) to (6).
Pi=Pi+α (4)
α=1 (5)
α=Cjmax (6)
In equation (4), variable α is a value for incrementing the similarity score Pi. If α is set to 1 as represented by equation (5), similarity score Pi represents the number of partial areas that have the same movement vector as reference movement vector Vi. If α is set to α=Cjmax as represented by equation (6), the similarity score Pi would be the total sum of the maximum matching scores obtained through the template matching of partial areas that have the same movement vector as the reference movement vector Vi. The value of variable a may be made smaller, in accordance with the magnitude of vector difference dVij.

In step S116, whether the value of index j is smaller than the total number n of partial areas or not is determined. If the value of index j is smaller than the total number n of partial areas (YES in S116), the flow proceeds to step S117, and if it is larger (NO in S116), the flow proceeds to step S118. In step S117, the value of index j is incremented by 1.

By the process from step S111 to S117, the similarity score Pi is calculated, using the information of partial areas determined to have the same movement vector as the reference movement vector Vi. In step S118, the similarity score using movement vector Vi as a reference is compared with the variable P(Ak, Ak+1), and if the similarity score Pi is larger than the largest similarity score (value of variable P(Ak, Ak+1)) obtained by that time (YES in S118), the flow proceeds to step S119, and otherwise the flow proceeds to step S120, skipping step S119.

In step S119, a value of similarity score Pi using movement vector Vi as a reference is set to the variable P(Ak, Ak+1). In steps S118 and S119, if the similarity score Pi using movement vector Vi as a reference is larger than the maximum value of the similarity score (value of variable P (Ak, Ak+1)) calculated by that time using other movement vector as a reference, the reference movement vector Vi is considered to be the best reference among the values of index i used to that time point.

In step S120, the value of index i of reference movement vector Vi is compared with the number (value of variable n) of partial areas. If the value of index i is smaller than the number n of partial areas (YES in S120), the flow proceeds to step S121, in which the index value i is incremented by 1.

As the process of steps S109 to S121 is repeated until the index i attains to the number n of partial areas (NO in S120), similarity between images Ak and Ak+1 is calculated as the value of variable P(Ak, Ak+1). Similarity score calculating unit 106 stores the value of variable P (Ak, Ak+1) calculated in the above described manner at a prescribed address of memory 102, and in step S122, average value Vk, k+1 of the area movement vector is calculated in accordance with the following equation (7).

$$Vk , k + 1 = ( {\sum }_{i = 1}^{n} Vi ) / n \qquad ( 7 )$$

The average value Vk, k+1 of the area movement vector calculated in accordance with equation (7) above is specifically shown in FIG. 8.

Here, average value Vk, k+1 of the area movement vector is calculated to obtain the relative positional relation between snap shot images Ak and Ak+1, based on the average value of movement vectors Vi of respective partial areas Qi of each of the snap shot images. In the specific example shown in FIG. 7, the average vector of area movement vectors V1, V2, . . . is given as V12.

Next, in step S123, the value of index k of snap shot image Ak as a reference image is compared with the number of snap shot images (value of variable m). If the index k is smaller than the number m of snap shot images (YES in S123), index k is incremented by 1 in step S124 and the flow returns to step S102, and the above described process is repeated. If the index k is not smaller than the number m of snap shot images (NO in S123), a calculation end signal is transmitted from control unit 108 to a calculating unit 1045 for relative positional relation between snap shot images, and the process ends.

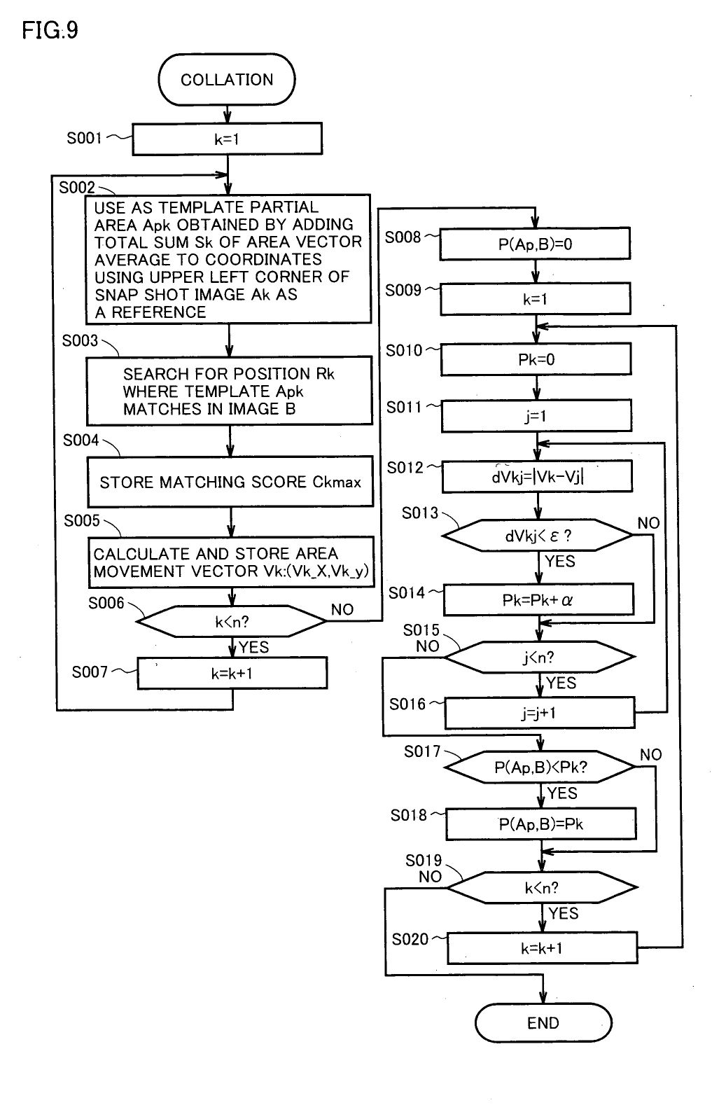

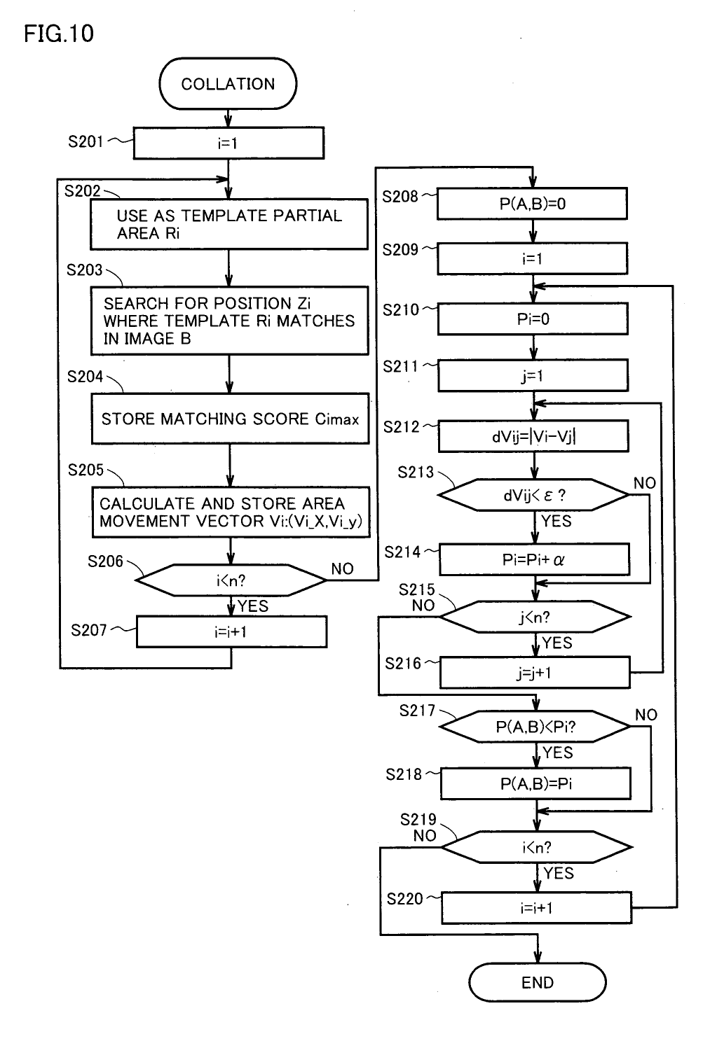

Next, the collating process performed in step T4 when the method of fingerprint input and collation is the sweep method (YES in T0.5E) will be described with reference to the flow chart of FIG. 9.

Control unit 108 transmits a template matching start signal to maximum matching score position searching unit 105, and waits until a template matching end signal is received. Maximum matching score position searching unit 105 starts a template matching process represented by steps S001 to S007.

The template matching process here is to find the maximum matching score position, which is the position of the partial area image where each of the set of snap shot images reflecting the reference position calculated by the calculating unit 1045 for relative positional relation between snap shot images described above attains the maximum matching score on an image different from the set of snap shot images.

First, in step S001, counter variable k is initialized to 1. Next, in step S002, an image of a partial area defined as Apk obtained by adding the total sum Pk of average value Vk, k+1 of area movement vectors to the coordinates of the upper left corner of snap shot image Ak as a reference, is set as a template to be used for the template matching. Here, Pk is defined by the following equation.

$$Pk = {\sum }_{i = 1}^{i - 1} Vi - 1 , i$$

In step S003, a portion of image B having the highest matching score with the template set in step S002, that is, a portion at which image data best match the template, is searched for. Specifically, we represent pixel density of coordinates (x, y), with an upper left corner of partial area Apk used as the template being the origin by Apk (x, y), pixel density of coordinates (s, t), with an upper left corner of image B being the origin by B(s, t), the width and height of partial area Apk by w and h, respectively, possible maximum density of each pixel in partial area Apk and image B by V0, and the matching score at coordinates (s, t) of image B by Ci(s, t), which matching score is calculated in accordance with the following equation (8), based on density difference between each of the pixels.

$$Ci ( s , t ) = {\sum }_{y = 1}^{h} {\sum }_{x = 1}^{w} ( V0 - \vert Apk ( x , y ) - B ( s + x , t + y ) \vert ) \qquad ( 8 )$$

In image B, the coordinates (s, t) are successively updated and the matching score C(s, t) at the coordinate (s, t) is calculated. A position having the highest value is considered as the maximum matching score position, the image of the partial area at that position is represented as partial area Rk, and the matching score at that position is represented as maximum matching score Ckmax. In step S004, the maximum matching score Ckmax in image B for the partial area Apk calculated in step S003 is stored in a prescribed address of memory 102. In step S005, a movement vector Vk is calculated in accordance with equation (9), which is stored at a prescribed address of memory 102.
Vk=(Vkx, Vky)=(Rkx−Apkx, Rky−Apky) (9)
Here, if the image B is scanned to identify the partial area Rk at the position R having the highest matching score with the partial area Apk based on the partial area Apk at position R set in image B, a directional vector from position Ap to position R is referred to as a movement vector. This is because the image B seems to have moved from image A as a reference, as the finger is placed in various manners on the fingerprint sensor.

In equation (9), variables Apkx and Apky are x and y coordinates at the reference position of partial area Apk obtained by adding the total sum Pn of average values Vk, k+1 of area movement vectors to the coordinates with the upper left corner of snap shot image Ak being the origin. Variables Rkx and Rky are x and y coordinates at the position of maximum matching score Ckmax as the result of search of partial area Rk, which correspond, by way of example, to the upper left corner coordinates of partial area Rk at the matched position in image B.

In step S006, whether the counter variable k is not larger than the total number of partial areas n or not is determined. If the variable k is not larger than the total number n of the partial areas (YES in S006), the flow proceeds to step S007 and otherwise, the process proceeds to step S008. In step S007, 1 is added to variable value k. Thereafter, as long as the variable value k is not larger than the total number n of partial areas, steps S002 to S007 are repeated, and for every partial area Apk, template matching is performed. Thus, maximum matching score Ckmax of each partial area Apk and the movement vector Vk are calculated.

Maximum matching score position searching unit 105 stores the maximum matching score Ckmax and the movement vector Vk for every partial area Apk calculated successively as described above at prescribed addresses of memory 102, and thereafter transmits a template matching end signal to control unit 108 to end the processing.

Thereafter, control unit 108 transmits a similarity score calculation start signal to similarity score calculating unit 106, and waits until a similarity score calculation end signal is received. Similarity score calculating unit 106 calculates the similarity score through the process of steps S008 to S020, using information such as the movement vector Vk and the maximum matching score Ckmax of each partial area Apk obtained by template matching and stored in memory 102.

Here, the calculation of similarity score refers to a process for determining whether one set of snap shot images match a separate image, using the maximum matching score position, which is the position of the partial area image where each of the set of snap shot images reflecting the reference position calculated by the calculating unit 1045 for relative positional relation between snap shot images described above attains the maximum matching score on an image different from the set of snap shot images, by calculating whether each positional relation value indicating the positional relation of each partial area that has been searched and the maximum matching score position is within a prescribed threshold value or not to determine similarity score, which serves as a basis to determine the matching mentioned above. Details of this process will be described in the following.

In step S008, similarity score P (Ap, B) is initialized to 0. Here, the similarity score P(Ap, B) is a variable storing the degree of similarity between images Ap and B. In step S009, an index k of the movement vector Vk as a reference is initialized to 1. In step S010, similarity score Pk related to the reference movement vector Vk is initialized to 0. In step S011, an index j of movement vector Vj is initialized to 1.

In step S012, vector difference dVkj between reference movement vector Vk and movement vector Vj is calculated in accordance with equation (10).
dVkj=|Vk−Vj|=sqrt {(Vkx−Vjx)²+(Vky−Vjy)²} (10)
Here, variables Vkx and Vky represent x direction and y direction components, respectively, of the movement vector Vk, variables Vkx and Vky represent x direction and y direction components, respectively, of the movement vector Vj, variable sqrt(X) represents square root of X and X² represents calculation of square of X.

In step S013, vector difference dVkj between movement vectors Vk and Vj is compared with a prescribed constant value ε, so as to determine whether the movement vectors Vk and Vj can be regarded as substantially the same vectors. If the vector difference dVkj is smaller than the constant value ε (YES in S013), movement vectors Vk and Vj are regarded as substantially the same, and the flow proceeds to step S014. If the difference is larger than the constant value (NO in S013), the movement vectors cannot be regarded as substantially the same, and the flow proceeds to step S015, skipping step S014. In step S014, the similarity score Pk is incremented in accordance with equations (11) to (13).
Pk=Pk+α (11)
α=1 (12)
α=Ckmax (13)
In equation (11), variable α is a value for incrementing the similarity score Pk. If α is set to 1 as represented by equation (12), similarity score Pk represents the number of partial areas that have the same movement vector as reference movement vector Vk. If α is set to α=Ckmax as represented by equation (13), the similarity score Pk would be the total sum of the maximum matching scores obtained through the template matching of partial areas that have the same movement vector as the reference movement vector Vk. The value of variable α may be made smaller, in accordance with the magnitude of vector difference dVkj.

In step S015, whether the value of index j is smaller than the total number n of partial areas or not is determined. If the value of index j is determined to be smaller than the total number n of partial areas (YES in S015), the flow proceeds to step S016, and if it is determined to be larger (NO in S015), the flow proceeds to step S017. In step S016, the value of index j is incremented by 1.

By the process from step S010 to S016, the similarity score Pk is calculated, using the information of partial areas determined to have the same movement vector as the reference movement vector Vk. In step S017, the similarity score using movement vector Vk as a reference is compared with the variable P(Ap, B), and if the similarity score Pk is larger than the largest similarity score (value of variable P(Ap, B)) obtained by that time (YES in S017), the flow proceeds to step S018, and otherwise the flow proceeds to step S019 skipping step S018.

In step S018, a value of similarity score Pk using movement vector Vk as a reference is set to the variable P(Ap, B). In steps S017 and S018, if the similarity score Pk using movement vector Vk as a reference is larger than the maximum value of the similarity score (value of variable P (Ap, B)) calculated by that time using other movement vector as a reference, the reference movement vector Vk is considered to be the best reference among the values of index k used to that time point.

In step S019, the value of index k of reference movement vector Vk is compared with the number (value of variable n) of partial areas. If the value of index k is smaller than the number n of partial areas (YES in S019), the flow proceeds to step S020, in which the index value k is incremented by 1.

As the process of steps S008 to S020 is repeated until the index k attains to the number n of partial areas (NO in S019), similarity between images Ap and B is calculated as the value of variable P(Ap, B). Similarity score calculating unit 106 stores the value of variable P (Ap, B) calculated in the above described manner at a prescribed address of memory 102, and transmits a similarity score calculation end signal to control unit 108 to end the process.

Next, the collating process performed in step T3 when the method of fingerprint input and collation is the area method (NO in T0.5) will be described with reference to the flow chart of FIG. 9.

Control unit 108 transmits a template matching start signal to maximum matching score position searching unit 105, and waits until a template matching end signal is received. Maximum matching score position searching unit 105 starts a template matching process represented by steps S201 to S207.

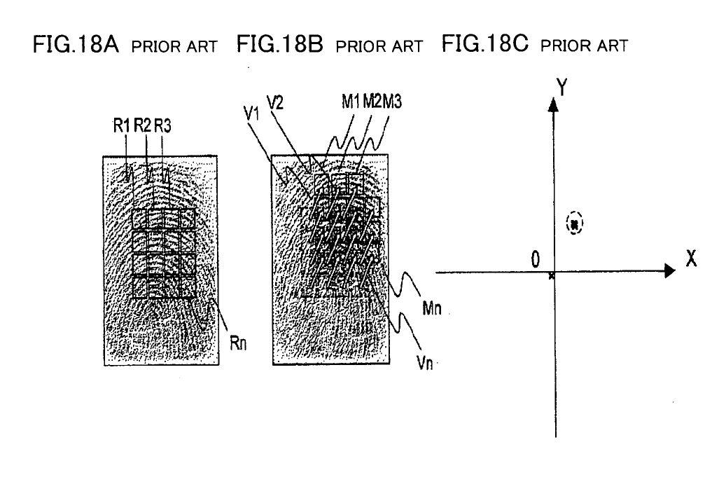

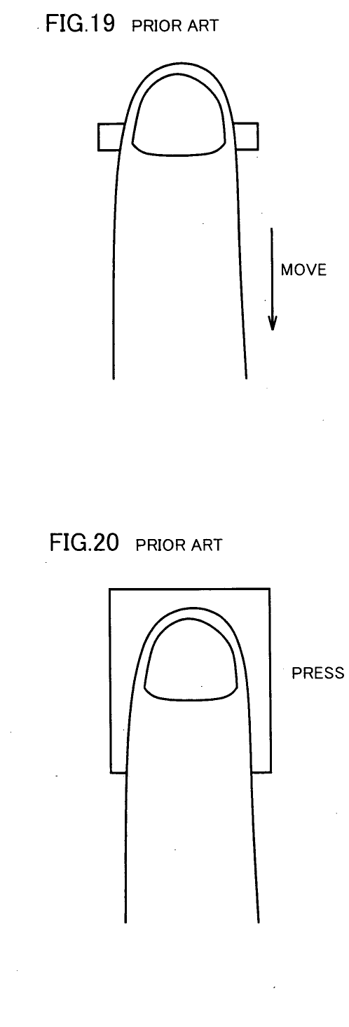

The template matching process here is, by way of example, to find to which area of the reference image the input image area R has moved, as shown in FIGS. 18A and 18B.

First, in step S201, a counter variable i is initialized to 1. In step S202, an image of a partial area Ri of image A, which is defined corresponding to the position P set in the image A as an object of collation, is set as a template to be used for the template matching. FIG. 11 shows an exemplary setting of partial area Ri, in which the snap shot image Ai is directly used as the partial area Ri. Though the partial area Ri has a rectangular shape for simplicity of calculation, the shape is not limited thereto.

In step S203, a portion of image B as a reference image having the highest matching score with the template set in step S202, that is, a portion at which image data best match the template, is searched for. Specifically, we represent pixel density of coordinates (x, y), with an upper left corner of partial area Ri used as the template being the origin by Ri (x, y), pixel density of coordinates (s, t), with an upper left corner of image B being the origin by B(s, t), the width and height of partial area Ri by w and h, respectively, possible maximum density of each pixel in images A and B by V0, and the matching score at coordinates (s, t) of image B by Ci(s, t), which matching score is calculated in accordance with the following equation (14), based on density difference between each of the pixels.

$$Ci ( s , t ) = {\sum }_{y = 1}^{h} {\sum }_{x = 1}^{w} ( V0 - \vert Ri ( x , y ) - B ( s + x , t + y ) \vert ) \qquad ( 14 )$$

In image B, the coordinates (s, t) are successively updated and the matching score C(s, t) is calculated. A position having the highest value is considered as the maximum matching score position, the image of the partial area at that position is represented as partial area Zi, and the matching score at that position is represented as maximum matching score Cimax. In step S204, the maximum matching score Cimax in image B for the partial area Ri calculated in step S203 is stored in a prescribed address of memory 102. In step S205, a movement vector Vi is calculated in accordance with equation (15), which is stored at a prescribed address of memory 102.
Vi=(Vix, Viy)=(Zix−Rix, Ziy−Riy) (15)
Here, if the image B is scanned to identify the partial area Zi at the position Z having the highest matching score with the partial area Ri, based on the partial area Ri at position R in image A, a directional vector from position R to position Z is referred to as a movement vector. This is because the image B seems to have moved from image A as a reference, as the finger is placed in various manners on the fingerprint sensor 100.

In equation (15), variables Rix and Riy are x and y coordinates at the reference position R of partial image Ri, that correspond, by way of example, to the upper left corner of partial image Ri. Variables Zix and Ziy are x and y coordinates at the position of maximum matching score Cimax as the result of search of partial area Zi, which correspond, by way of example, to the upper left corner coordinates of partial area Zi at the matched position in image B.

In step S206, whether the counter variable i is not larger than the number of partial areas n or not is determined. If the variable i is not larger than the total number n of the partial area (YES in S206), the flow proceeds to step S207, and otherwise (NO in S206), the process proceeds to step S208. In step S207, variable value i is incremented by 1. Thereafter, as long as the variable value i is not larger than the total number n of partial areas, steps S202 to S207 are repeated. Namely, for every partial area Qi, template matching is performed and the maximum matching score Cimax of each partial area Qi and the movement vector Vi are calculated.

Maximum matching score position searching unit 105 stores the maximum matching score Cimax and the movement vector Vi for every partial area Qi calculated successively as described above at prescribed addresses of memory 102, and thereafter transmits a template matching end signal to control unit 108.

Thereafter, control unit 108 transmits a similarity score calculation start signal to similarity score calculating unit 106, and waits until a similarity score calculation end signal is received. Similarity score calculating unit 106 calculates the similarity score through the process of steps S208 to S220, using information such as the movement vector Vi and the maximum matching score Cimax of each partial area Ri obtained by template matching and stored in memory 102.

The similarity score calculating process here is to calculate whether all the partial areas are within a prescribed area or not, as shown in FIG. 18C.

In step S208, similarity score P (A, B) is initialized to 0. Here, the similarity score P(A, B) is a variable storing the degree of similarity between the image A as an object of collation and the image B as a reference image. In step S209, an index i of the movement vector Vi as a reference is initialized to 1. In step S210, similarity score Pi related to the reference movement vector Vi is initialized to 0. In step S211, an index j of movement vector Vj is initialized to 1.

In step S212, vector difference dVij between reference movement vector Vi and movement vector Vj is calculated in accordance with equation (16).
dVij=|Vi−Vj|=sqrt {(Vix−Vjx)²+(Viy−Vjy)²} (16)
Here, variables Vix and Viy represent x direction and y direction components, respectively, of the movement vector Vi, variables Vjx and Vjy represent x direction and y direction components, respectively, of the movement vector Vj, variable sqrt(X) represents square root of X and X² represents calculation of square of X.

In step S213, vector difference dVij between movement vectors Vi and Vj is compared with a prescribed constant value ε, so as to determine whether the movement vectors Vi and Vj can be regarded as substantially the same vectors. If the vector difference dVij is smaller than the constant value ε (YES in S213), movement vectors Vi and Vj are regarded as substantially the same, and the flow proceeds to step S214. If the difference is larger than the constant value (NO in S213), the movement vectors cannot be regarded as substantially the same, and the flow proceeds to step S215, skipping step S214. In step S214, the similarity score Pi is incremented in accordance with equations (17) to (19).
Pi=Pi+α (17)
α=1 (18)
α=Cimax (19)
In equation (17), variable α is a value for incrementing the similarity score Pi. If α is set to 1 as represented by equation (18), similarity score Pi represents the number of partial areas that have the same movement vector as reference movement vector Vi. If α is set to α=Cimax as represented by equation (19), the similarity score Pi would be the total sum of the maximum matching scores obtained through the template matching of partial areas that have the same movement vector as the reference movement vector Vi. The value of variable α may be made smaller, in accordance with the magnitude of vector difference dVij.

In step S215, whether the value of index j is smaller than the total number n of partial areas or not is determined. If the value of index j is smaller than the total number n of partial areas (YES in S215), the flow proceeds to step S216, and if it is larger (NO in S215), the flow proceeds to step S217. In step S216, the value of index j is incremented by 1.

By the process from step S210 to S216, the similarity score Pi is calculated, using the information of partial areas determined to have the same movement vector as the reference movement vector Vi. In step S217, the similarity score using movement vector Vi as a reference is compared with the variable P(A, B), and if the similarity score Pi is larger than the largest similarity score (value of variable P(A, B)) obtained by that time (YES in S217), the flow proceeds to step S218, and if it is smaller (NO in S217), the flow proceeds to step S219, skipping step S218.

In step S218, a value of similarity score Pi using movement vector Vi as a reference is set to the variable P(A, B). In steps S217 and S218, if the similarity score Pi using movement vector Vi as a reference is larger than the maximum value of the similarity score (value of variable P (A, B)) calculated by that time using other movement vector as a reference, the reference movement vector Vi is considered to be the best reference among the values of index i used to that time point.

Next, in step S219, the value of index i of reference movement vector Vi is compared with the number (value of variable n) of partial areas. If the value of index i is smaller than the number n of partial areas, the flow proceeds to step S220, in which the index value i is incremented by 1.

As the steps S208 to S220 described above are repeated until the index i becomes equal to the number n of partial areas (NO in S219), similarity between images A and B is calculated as the value of variable P(A, B). Similarity score calculating unit 106 stores the value of variable P (A, B) calculated in the above described manner at a prescribed address of memory 102, and transmits a similarity score calculation end signal to control unit 108 to end the process.

The determination in step T4 will be specifically described in the following. In step T4, the similarity score represented by the value of variable P(Ap, B) (or variable P(A, B)) stored in memory 102 is compared with a predetermined threshold T for collation (FIG. 11). As a result of comparison, if P≧T, it is determined that images A (or Ap) and B are taken from one same fingerprint, a value, for example, 1, indicating a match is written to a prescribed address of memory 102 as a collation result, and if not, the images are determined to be taken from different fingerprints and a value, for example, 0, indicating a mismatch is written to a prescribed address of memory 102. It is noted that the radius of the circle in FIG. 12 corresponds to the constant ε used in the process of S213. In S214, to those of the movement vectors that are within this circle, α is added to the variable P (A, B). In the determination mentioned above, the variable P (A, B) as such is compared with T, to determine whether the images match. In other words, if α is “1”, the images are determined to be matching, if there are T or more movement vectors found in the circle.

In this manner, image collating-apparatus 1 in accordance with the present embodiment allows switching of sensing methods between the sweep sensing method and the area sensing method, dependent on the level of confidentiality. Therefore, switching is possible between a highly accurate method for higher confidentiality and an easier method where convenience is given priority, using conventional sweep type or similar sensor without necessitating additional cost for the sensor and suppressing the cost as compared with the use of the area type sensor.

### Second Embodiment

The image collating apparatus 1 of the present embodiment allows user's application-by-application setting of either the area method or the sweep method as the method of fingerprint input and collation, and determining which method of fingerprint input and collation has been set, image collation is performed accordingly. The function and configuration of image collating apparatus of the present embodiment are similar to those of image collating apparatus 1 in accordance with the first embodiment (FIG. 1), and specific example of the computer configuration on which image collating apparatus 1 of the present embodiment is mounted is the same as the specific example of the computer configuration on which image collating apparatus 1 in accordance with the first embodiment is mounted (FIG. 3).

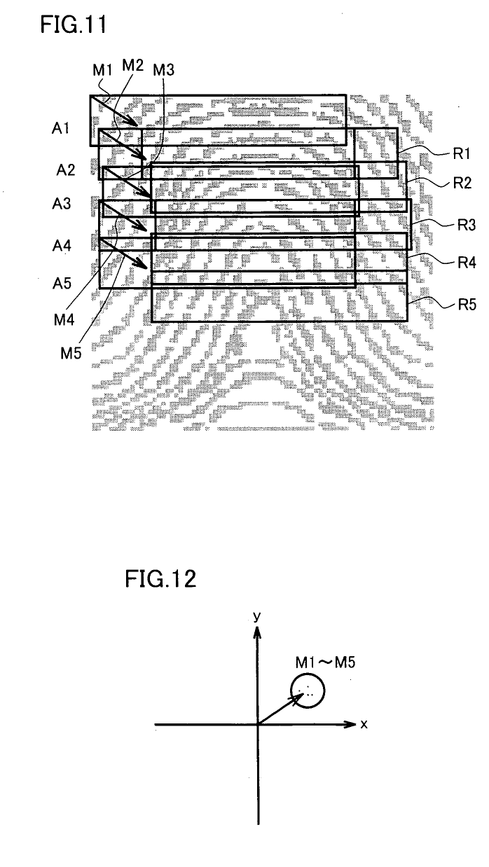

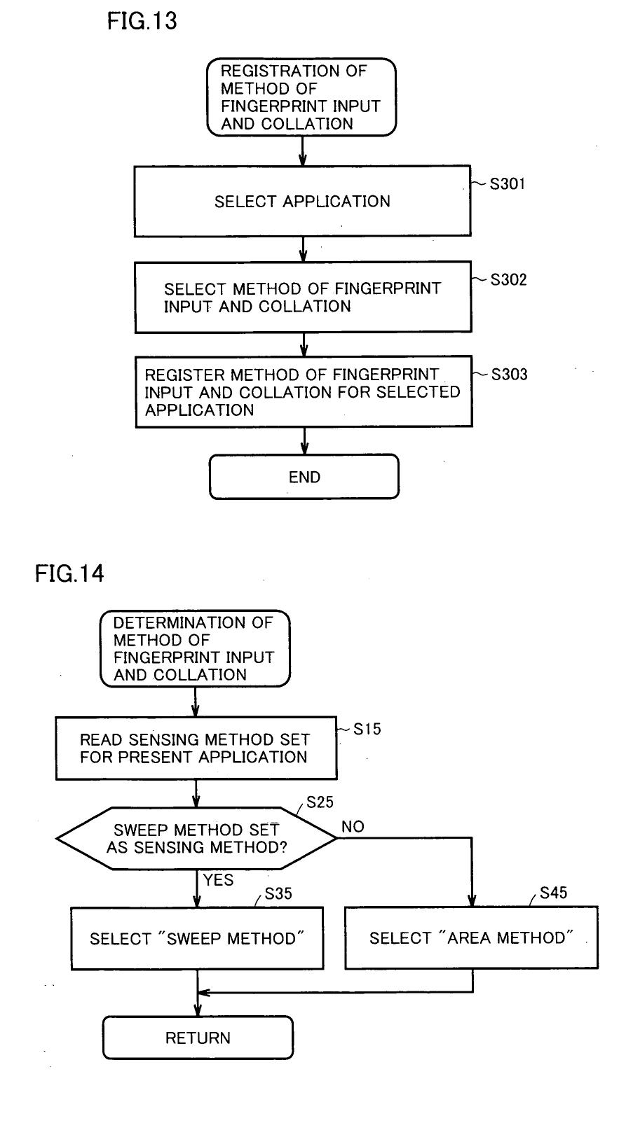

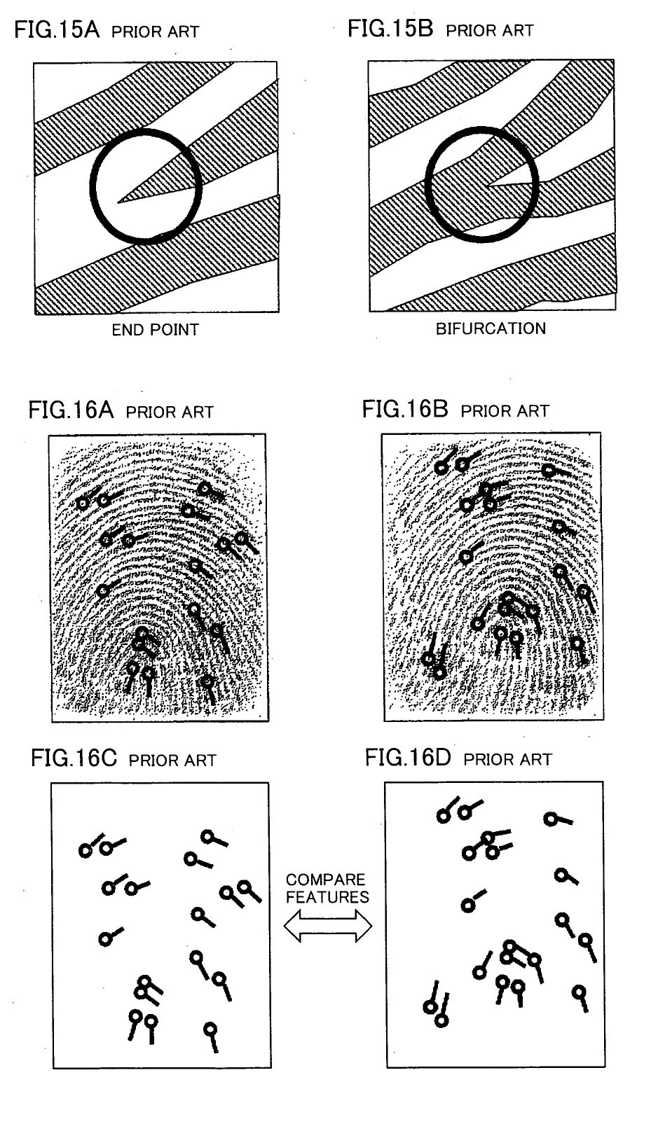

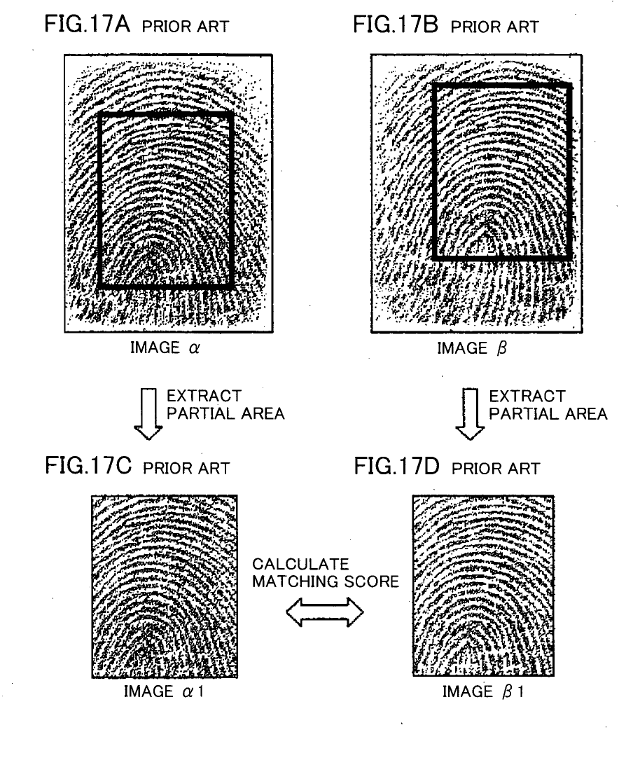

First, the process for setting either the area method or sweep method application by application as the method of fingerprint image input and collation will be described with reference to the flow chart of FIG. 13. The process shown in FIG. 13 is also realized by CPU 622 of the computer, on which image collating apparatus 1 of the present invention is mounted, reading the corresponding program stored in the ROM or the like, loading the same on the RAM and executing the program while controlling various portions shown in FIG. 1.

Referring to FIG. 13, first, the user selects an application as an object for which the method of fingerprint input and collation is registered (S301). Then, the user selects the method of fingerprint input and collation for the application (S302). Specifically, either the sweep method or the area method is selected as the method of fingerprint input and collation for that application. The selected method of fingerprint input and collation is written to and registered in the setting of the application in memory 102 (S303), and the process ends.

The method of image collation by image collating apparatus 1 of the present embodiment is also the same as the method of image collation described with reference to the flow chart of FIG. 4 of the first embodiment, and in step T0, the method of fingerprint input and collation set by the user as described above is determined.

The contents of the process for determining the method of fingerprint input and collation in step T0 by image collating apparatus 1 of the present embodiment are as shown in FIG. 14.

Referring to FIG. 14, first, control unit 108 reads the method of fingerprint input and collation (sensing method) set by the user for the presently running application from memory 102 (S15). In accordance with the method of fingerprint input and collation set by the user and read from memory 102 in step S15 (S25), the sweep method or area method is output as the method of fingerprint input and collation (S35 or S45).

In image collating apparatus 1 of the present embodiment, in accordance with the method of fingerprint input and collation set by the user for the application read in this manner, the process starting from step T1 of FIG. 4 is performed. Specifically, in image collating apparatus 1 of the present embodiment, it is possible to switch between the sweep sensing method and the area sensing method by user setting. Therefore, switching is possible between a highly accurate method for higher confidentiality and an easier method where convenience is given priority, using conventional sweep type or similar sensor without necessitating additional cost for the sensor and suppressing the cost as compared with the use of the area type sensor.

### Third Embodiment

The process functions of image collating apparatus 1 for image collation described in the first and second embodiments are implemented by a program. In the present embodiment, the program is stored in a computer-readable recording medium.

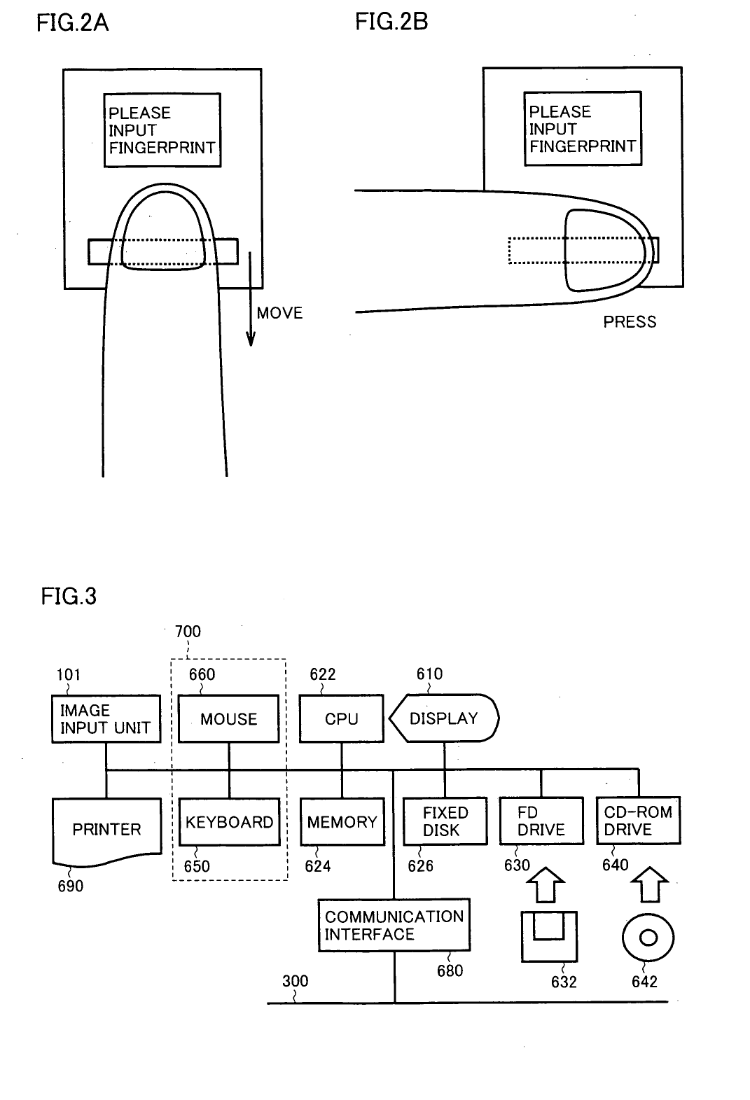

As for the recording medium, in the present embodiment, the program medium may be a memory necessary for the processing by the computer shown in FIG. 3, such as memory 624, or, alternatively, it may be a recording medium detachably mounted on an external storage device of the computer and the program recorded thereon may be read through the external storage device. Examples of such an external storage device are a magnetic tape device (not shown), an FD drive 630 and a CD-ROM drive 640, and examples of such a recording medium are a magnetic tape (not shown), an FD 632 and a CD-ROM 642. In any case, the program recorded on each recording medium may be accessed and executed by CPU 622, or the program may be once read from the recording medium and loaded to a prescribed storage area shown in FIG. 2, such as a program storage area of memory 624, and then read and executed by CPU 622. The program for loading is stored in advance in the computer.

Here, the recording medium mentioned above is detachable from the computer body. A medium fixedly carrying the program may be used as the recording medium. Specific examples may include tapes such as magnetic tapes and cassette tapes, discs including magnetic discs such as FD 623 and fixed disk 626 and optical discs such as CD-ROM 642/MO(Magnetic Optical Disc)/MD(Mini Disc)/DVD(Digital Versatile Disc), cards such as an IC card (including memory card)/optical card, and semiconductor memories such as a mask ROM, EPROM (Erasable and Programmable ROM), EEPROM (Electrically EPROM) and a flash ROM.

The computer shown in FIG. 3 has a configuration that allows connection to a communication network 300 including the Internet for establishing communication. Therefore, the program may be downloaded from communication network 300 and held on a recording medium in a non-fixed manner. When the program is downloaded from a communication network, the program for downloading may be stored in advance in the computer, or it may be installed in advance from a different recording medium.

The contents stored in the recording medium are not limited to a program, and may include data.

Although the present invention has been described and illustrated in detail, it is clearly understood that the same is by way of illustration and example only and is not-to be taken by way of limitation, the spirit and scope of the present invention being limited only by the terms of the appended claims.

1. An image collating apparatus, comprising:
an image input unit including a sensor and allowing input of an image of an object either through a first method in which relative position between said sensor and said object is fixed or a second method in which relative position between said sensor and said object is changed;
a reference image holding unit holding a reference image to be collated with an input image input to said image input unit;
a first collating unit collating a first input image input to said image input unit through said first method with said reference image;
a second collating unit collating a second input image input to said image input unit through said second method with said reference image;
a purpose information storing unit storing information related to a purpose of collation of said input image;
a determining unit determining, in accordance with the purpose of collation stored in said purpose information storing unit, whether an image of said object is to be input to said image input unit through said first method to be collated by said first collating unit, or an image of said object is to be input to said image input unit through said second method to be collated by said second collating unit; and
a selecting unit selecting either said first method or said second method as the method of inputting the image of said object to said image input unit, in accordance with the result of determination by said determining unit.

2. The image collating apparatus according to claim 1, wherein said purpose information storing unit stores, as the information related to the purpose of collation, a confidentiality level related to an application being executed by said image collating apparatus; and
said determining unit determines, in accordance with the confidentiality level related to an application being executed by said image collating apparatus stored in said purpose information storing unit, whether an image of said object is to be input to said image input unit through said first method to be collated by said first collating unit, or an image of said object is to be input to said image input unit through said second method to be collated by said second collating unit.

3. The image collating apparatus according to claim 1, further comprising:
a setting information holding unit, receiving a setting as to whether an image of said object is to be input to said image input unit through said first method to be collated by said first collating unit, or an image of said object is to be input to said image input unit through said second method to be collated by said second collating unit in accordance with the information related to the purpose of collation and holding said setting; wherein
said determining unit determines, based on said setting held by said setting information holding unit, whether an image of said object is to be input to said image input unit through said first method to be collated by said first collating unit, or an image of said object is to be input to said image input unit through said second method to be collated by said second collating unit.

4. The image collating apparatus according to claim 3, wherein
said setting information holding unit is a rewritable memory that allows resetting as to whether an image of said object is to be input to said image input unit through said first method to be collated by said first collating unit, or an image of said object is to be input to said image input unit through said second method to be collated by said second collating unit.

5. An image collating method, comprising:
an image input step of inputting an image of an object by image input means allowing input of an image of said object either through a first method in which relative position between said sensor and said object is fixed or a second method in which relative position between said sensor and said object is changed, either through said first method or said second method;
a determining step of determining, in accordance with information related to a purpose of collation, whether said image of said object is input through said first method or second method in said image input step;
a selecting step of selecting, in accordance with the result of determination of said determining step, either said first method or said second method as the method of inputting an image of said object in said image input step;
a first collating step of collating, when said first method is selected in said selecting step as the method of inputting an image of said object in said image input step, a first input image input through said first method in said image input step with a reference image for collation with the input image input in said image input step; and
a second collating step of collating, when said second method is selected in said selecting step as the method of inputting an image of said object in said image input step, a second input image input through said second method in said image input step with said reference image.

6. An image collating program causing a computer to execute an image collating method, said method including
an image input step of inputting an image of an object by image input means allowing input of an image of said object either through a first method in which relative position between said sensor and said object is fixed or a second method in which relative position between said sensor and said object is changed, either through said first method or said second method;
a determining step of determining, in accordance with information related to a purpose of collation, whether said image of said object is input through said first method or second method in said image input step;
a selecting step of selecting, in accordance with the result of determination of said determining step, either said first method or said second method as the method of inputting an image of said object in said image input step;
a first collating step of collating, when said first method is selected in said selecting step as the method of inputting an image of said object in said image input step, a first input image input through said first method in said image input step with a reference image for collation with the input image input in said image input step; and
a second collating step of collating, when said second method is selected in said selecting step as the method of inputting an image of said object in said image input step, a second input image input through said second method in said image input step with said reference image.

7. A computer readable recording medium recording the image collating program according to claim 6.
